(19) United States
(12) Patent Application Publication
(10) Pub. No.: US 2018/0108185 A1
(43) Pub. Date: Apr. 19, 2018

(54) METHOD AND COMPUTER SYSTEM FOR VIRTUALLY DISPLAYING IMAGES ON CARTON BOXES

(71) Applicant: INTERNATIONAL BOXES S.R.L., CIMADOLMO (IT)

(72) Inventor: Giuseppe CAPOIA, CIMADOLMO (TV) (IT)

(21) Appl. No.: 15/735,851

(22) PCT Filed: Jun. 16, 2016
(86) PCT No.: PCT/EP2016/063968

§ 371 Date: Dec. 12, 2017

(30) Foreign Application Priority Data
Jun. 17, 2015 (IT) 102015000024897

(51) Int. Cl. G06T 19/20; G06F 17/50

(52) U.S. Cl. CPC G06T 19/20; G06F 17/50; G06T 2219/2024; G06T 2219/2021; G06F 2217/38; G06T 2219/2008

(57) ABSTRACT

A method of operating a processing system that includes at least one processor and a storage system.

### FIELD OF THE INVENTION

A method of operating a processing system that includes at least one processor and a storage system, wherein said method is characterized in virtually displaying three dimensional images of carton boxes on computer screen and optimizing the parameters for image printing on at least one surface or flap of said three dimensional image of carton box; and wherein said method is further characterized in the interactive instructions and tools towards controlling and guiding the generation and modification of virtual three dimensional images, selecting one or more optional parametric values. The proposed method includes a computer readable medium with coded instructions to execute the method towards virtually displaying three-dimensional images of carton boxes on computer screen and optimizing the parameters for image printing thereof.

### BACKGROUND OF THE INVENTION

The processing of sheet material to transform such sheet material to a useable form such as a carton box, normally involves utilizing one or more working units to cut and/or crease a blank from the sheet material and provide it with various cuts, incisions, scores, slits, creases etc. for the purpose of forming tear strips, punch outs, fold lines, bending lines etc. in the blank. For instance, document WO-A-2011/007237 in the name of the Applicant discloses a known machine for cutting and/or pre-creasing a carton blank or sheet for making carton boxes.

These cuts, scores, slits, creases etc. are commonly formed through the use of cutting and creasing working tools, such as discs or rolls mounted into or onto the working tool. To facilitate folding of sheet material such as corrugated paperboard, fold lines, or intended bending lines, are formed in the material by creasing working units commonly referred to as creasing discs or rolls. For instance, documents WO-A-2010/029416 and WO-A-2012/131482 in the name of the Applicant disclose known tools for working a carton blank or sheet for making carton boxes.

Accordingly, there is a need in the art for manufacturing a carton from a sheet material such as cardboard. There is also a need in the art for an apparatus and method for forming such a folding score.

Document U.S. Pat. No. 7,346,408 discloses a two-dimensional graphic for incorporating on three-dimensional objects.

Document US-A-2007/248394 discloses a system and method for ordering and producing a made-to-order corrugated product.

There is therefore a need to improve a method and computer system for virtually displaying images on carton boxes, in particular for carton packaging boxes, which overcomes at least one of the drawbacks of the prior art.

In particular, one object of the present invention is to propose a method and a system for generating a virtual three dimensional diagram of a packaging carton (box) on the computer screen, wherein said method allows the user to modulate the shape, size, angle of bending, orientation of the flap and dimensions of various parts of said virtual three dimensional diagram of the packaging carton. Another object of the invention is to propose a method that also provisions interactive tools for integrated prints management on at least one flap of said three-dimensional diagram of a packaging carton (box).

Another object of the invention is to propose the logic and instructions encoded for one or more computer readable medium to execute and control whole process of virtual creation of diagrams, modulation of their shape, size and dimension and managing the printing on at least one surface or flap.

### SUMMARY OF THE INVENTION

Embodiments described herein refer to a method of operating a processing system that includes at least one processor, or computing device, and a storage system. According to one embodiment, the method includes:

selecting one desired type of carton box from a group or list of available different types of carton boxes displayed on computer screen according to a computer program code;
generating, by said computer program code, virtually displaying three dimensional images of carton boxes on the computer screen, said virtually displaying comprising three-dimensionally displaying a progressive formation of a selected final closed carton box by bending and/or rotating flaps, walls or surfaces of a starting carton blank sheet made of corrugated paperboard having a mating, or conjugated, shape, and intended for the formation of said selected final closed carton box;
wherein at least said virtually displaying is provided according to the interactive instructions and tools configured towards controlling and guiding the generation and modification of virtual three dimensional images, selecting one or more optional parametric values. According to embodiments, the logic and instructions encoded for one or more computer readable medium to execute said method are encoded in XML format.

According to further embodiments, the logic and instructions encoded for one or more computer readable medium to execute said method are encoded in a text string, in particular containing alphanumeric characters, such as based on an ASCII table.

According to still further embodiments, the logic and instructions encoded for one or more computer readable medium to execute said method are encoded in an electronic database, in particular are based on a database query, for example using standard SQL (Structured Query Language).

According to yet further embodiments the logic and instructions encoded for one or more computer readable medium to execute said method are encoded in an electronic spreadsheet.

According to a further embodiment, the method provides a computer readable medium with coded instructions to execute the method towards virtually displaying three-dimensional images of carton boxes on computer screen and optionally optimizing parameters for image printing thereof.

According to a further embodiment, the method comprises optimizing parameters for image printing on at least one surface or flap of said three-dimensional image of carton box.

Embodiments described herein generally relate to a system and method that visualize the 3-D pattern of carton box on computer screen wherein said system enabled with computer readable logic and instructions encoded thereon to modulate and alter the shape, size and dimension of said virtual carton box visible on the computer screen. Further embodiments described herein includes proposing a computer readable storage medium having the logics and instructions encoded thereon that when executed by one or more processors of a processing system that includes at least one processor and storage subsystem, cause execution of the method comprising creation of virtual diagrams, modulation of their shape, size and dimension and managing the printing on at least one surface or flap.

According to another embodiment described herein, a computer system and method for 3-D visualization of cartons are provided wherein various operations are performed namely shaping, cutting, bending and printing on virtual carton box visible on the computer screen.

Yet another embodiment described herein provides to perform first operation i.e. shaping operation, wherein the user can decide and select different types of boxes from the available box options in the software.

Yet another embodiment described herein provides to perform cutting operation, wherein the material used for creating a carton box is cardboard sheet. The cutting operation is performed at particular dimensions specify by the user according to their requirement.

Yet another embodiment described herein provides to perform the bending operation, wherein the slotted material sheet is bended at particular position to gain the exact shape. After the completion of bended operation the final carton box is ready.

Yet another embodiment described herein provides to perform printing operation, wherein an image is imposed over the different surface/flaps of the carton, these images are positioned by drag and drop method. The printing patterns can be selected on perfect parametric positions on chosen surface/flap. Embodiments described herein also refer to using integrated image conversion tool with dithering, wherein an attempt is made by a computer program to approximate a color from a mixture of other colors when the required color is not available.

Yet another embodiment described herein provides to enable the user to decide the alignment, shape and size of virtual carton box visible on the computer screen applying the logic and instructions available with the system.

According to some possible implementations, the logic and instructions can be encoded in XML format.

In other possible implementations, the logic and instructions can be encoded as a text string, in particular containing alphanumeric characters, i.e. characters string, such as based on an ASCII table.

In further possible implementations, the logic and instructions can be encoded in an electronic database, in particular are based on a database query, for example using standard SQL (Structured Query Language).

In yet further possible implementations, the logic and instructions can be encoded in an electronic spreadsheet. Further embodiments described herein relate to a method and a system using which in use is capable of generating a virtual three dimensional diagram of a packaging carton box on the computer screen, wherein said method allows the user to modulate the shape, size, angle of bending, orientation of the flap and dimensions of various parts of said virtual three dimensional diagram of the packaging carton. Further the proposed method also provisions interactive tools for integrated prints management on at least one flap of said three-dimensional diagram of a packaging carton box. Said system helps in deciding the size and orientation of the image or text for printing on the flap and through its integrated image conversion tools, for instance with dithering, it helps in replacing one image form another by suitably calculating and customizing the parametric positioning of the images. Such activities of the user towards generation and modulation of virtual 3-D packaging carton on a computer screen and the prints management thereof are controlled and guided by a programming. For example, the programming can be XML based, or using a text string, or a query database or an electronic spreadsheet. Such generation and modulation of virtual 3-D packaging carton on a computer screen and the management of print quality and its positioning thereof enables the user to feed command to the machine for PLC program guided automated production of actual 3-D packaging carton and for realizing automated printing of images or texts on at least one part or flap of the carton box.

In embodiments described herein the said system is controlled and guided by a program or file, wherein depending on personalized requirements, one can change parametric values for carton designing and for printing thereto.

The program or file can for example be XML based, or a text string, or a query database or an electronic spreadsheet.

Towards management of printing operation on at least one surface or flap of said virtual carton box visible on the computer screen, an image is selected and imposed over different surfaces/flaps of the carton, wherein these images are positioned by drag and drop method. The printing patterns can be selected on perfect parametric positions on chosen surface/flap. Said invention also uses integrated image conversion tool with dithering, wherein an attempt is made by a computer program to approximate a color from a mixture of other colors when the required color is not available.

Embodiments described herein further refer to a non-transitory computer readable medium including at least computer program code for executing a method according the present disclosure.

Further embodiments described herein refer to a user terminal, wherein said user terminal comprises:

a computing device configured to execute computer program code for executing a method according the present disclosure;
a data storage device configured to store computer program code that is able to be executed by the computing device, the computer program code stored in the data storage device including at least:
computer program code for providing an interface to receive a plurality of inputs from a user of the user terminal, wherein said plurality of inputs is intended to select at least one desired type of carton box from a group or list of available different types of carton boxes displayed on computer screen.

In one embodiment, the computer program code stored in the data storage device further includes computer program code for providing an interface to receive a plurality of inputs from a user of the user terminal, wherein said plurality of inputs is intended to select; control, position at least one image printing on at least one surface or flap of the three dimensional image of carton box.

Yet further embodiments described herein refer to a server comprising:

a database to store at least a plurality of personalized preferences, wherein the preferences are collected from a plurality of users;
a processing device configured to create clusters of the personalized preferences according to a plurality of parameters;
wherein the personalized preferences are personalized preferences regarding at least specific and/or most recurrent desired types of carton boxes selected by a user from a group or list of available different types of carton boxes and optionally regarding specific/or most recurrent desired image printings on at least one surface or flap of the three dimensional image of carton box.

Embodiments described herein further refer a computer system for visually and virtually aiding and/or guiding a user and/or operator at least in the formation of carton boxes. In one embodiment, the computer system comprises a data storage means storing computer program code that is able to be executed by a computing device, the computer program code being configured to provide an interface to a user to provide a plurality of inputs, wherein the provided inputs are used by the computer code at least to generate execute a method according to the present disclosure.

These and other features, aspects and advantages of the present disclosure will become better understood with reference to the following description, the drawings and appended claims. The drawings, which are incorporated in and constitute a part of this specification, illustrate embodiments of the present subject matter and, together with the description, serve to explain the principles of the disclosure.

The various aspects and features described in the present disclosure can be applied, individually, wherever possible. These individual aspects, for instance the aspects and features described in the attached dependent claims, can be made subject of divisional patent applications.

It is noted that anything found to be already known during the patenting process is understood not to be claimed and to be the subject of a disclaimer.

### BRIEF DESCRIPTION OF THE DRAWINGS

So that the manner in which the above recited features of the present invention can be understood in detail, a more particular description of the invention, briefly summarized above, may be had by reference to embodiments. The accompanying drawings relate to embodiments of the disclosure and are described in the following:

FIG. 1: shows the flow chart of one method embodiment of the invention.

FIG. 2: Shows the schematic view of an example, a simplified block diagram of system components of a design system that may be used to operate a method embodiment of the invention.

FIG. 3: One schematic view of sheet for deciding the length & width of different flaps for bending & cutting.

FIG. 4: One schematic view shows bending of various sections/flaps of the box.

FIG. 5: One schematic view represents the selecting the box design from the interactive selection tool provisioned in the system and thereafter refining the dimensions as per requirements.

FIG. 6: Interactive tools towards measuring and changing various parameters of the selected box.

FIG. 7: Positioning of image and optimization of image as per surface/flap.

FIG. 8: Printing images at different flaps/surface by drag and drop.

FIG. 9: Easy image rotation at preferred angle.

### DETAILED DESCRIPTION OF THE EMBODIMENTS

Reference will now be made in detail to the various embodiments of the invention, one or more examples of which are illustrated in the figures. Within the following description of the drawings, the same reference numbers refer to the same components. Generally, only the differences with respect to individual embodiments are described. Each example is provided by way of explanation of the invention and is not meant as a limitation of the invention. For example, features illustrated or described as part of one embodiment can be used on or in conjunction with other embodiments to yield yet a further embodiment. It is intended that the present invention includes such modifications and variations.

Carton boxes and the like (collectively referred to herein as cartons) are commonly formed into 3D-shapes from a plane surface such as cardboard, although other material may be used. The material sheet (cardboard) is often printed with graphics, scored, and then bended at edges through a typically 90° bend angle to form the three-dimensional shape of the carton. The various surface of the carton, e.g., top, bottom, sides in the case of a rectangular box, are often referred to as surfaces, and a surface may be formed from, or include, several flaps.

Thus, in this description, a surface is a flat part of the final 3D-shape of the carton, and a flap is a part of the unfolded design. Each surface has one flap, and some may have more.

Embodiments described herein refer to a method of operating a processing system for providing display or on-screen visual aids and instructions to an user for the execution of operations for the formation of a final closed carton by starting from a shaped carton blank sheet. The processing system operated by the method of the invention includes at least one processor, or computing device, and a storage system.

The method includes selecting one desired type of carton box from a group or list of available different types of carton boxes displayed on computer screen according to a computer program code. Selection can be made by using a suitable graphic user interface and suitable input device or means, associated with the processor, or computing device.

The method further includes generating, by said computer program code, virtually displaying three-dimensional images of carton boxes on the computer screen.

According to embodiments, instructions, markers and/or descriptors for generating said virtually displaying three dimensional images may be included in an XML file generated and formatted in order to be processed by the processor, or computing device.

According to further embodiments, instructions, markers and/or descriptors for generating said virtually displaying three dimensional images may be included in a text string, or in a database or a spreadsheet, or combination thereof:

According to embodiments, the virtually displaying comprises three-dimensionally displaying a progressive formation of a selected final closed carton box by bending and/or rotating flaps, walls or surfaces of a starting carton blank sheet made of corrugated paperboard having a mating, or conjugated, shape and intended for the formation of said selected final closed carton box.

According to embodiments, at least said virtually displaying is provided according to the interactive instructions and tools configured towards controlling and guiding the generation and modification of virtual three dimensional images, selecting one or more optional parametric values.

According to embodiments, the logic and instructions encoded for one or more computer readable medium to execute the said method are encoded in XML format.

According to further embodiments, the logic and instructions encoded for one or more computer readable medium to execute the said method may be encoded in a text string, or in a database or a spreadsheet, or combination thereof.

According to embodiments of the present disclosure, combinable with all embodiments described herein, the term “logic” can be used to identify logical functions and/or operations and/or logical operations collectively. The term “logic” may also be used to identify, in particular, a system or set of principles underlying the arrangements of elements in a computer or electronic device so as to perform a specified task.

In embodiments described herein, the packaging industries that uses machines or apparatuses for making carton box can be provided with a suitable format file according to the present disclosure, in order to efficiently command and control the above mentioned machines and apparatuses and also in order to visually and virtually aid and support the user in the operations for forming the final closed carton box The suitable format file can be, for instance, an XML format file, a text string, or a database query or a spreadsheet.

For instance, a suitable XML format file used for designing of packaging cartons, can be obtained by using an XML editor software and CAD or CAD-like software to create a virtual model of such cartons on computers. The same approach can be used to create a text string, or a database or a spreadsheet.

Computerized tools can be used to aid in the structural design of the carton by embedding folding information in the structural design, and to allow the graphical designer to take a flat or planar layout and, using folding information, view the design on a computer monitor in a rendered 3-D form according to the present disclosure.

Actually, it may be very challenging to design and print graphics on a cardboard to ensure that after the carton is cut from the cardboard and bended, the various graphic images will have been printed with proper alignment, size and shape, for example when there is an image on more than one flap. In the prior art, designing and creating such graphics is both labor intensive and very prone to error, including error from print bleeding. The present disclosure overcomes this shortcomings by providing a computerized management system of printing operations integrated in embodiments of the method according to the present disclosure.

Therefore, further embodiments of the present invention disclose also a computer program code or software by which one can print an image on 3-D object such as carton box, and more specifically to a computerized graphic design method to facilitate proper alignment and sizing of images printed on, a cardboard from which flaps and surfaces are cut and bended to form a three dimensional carton box.

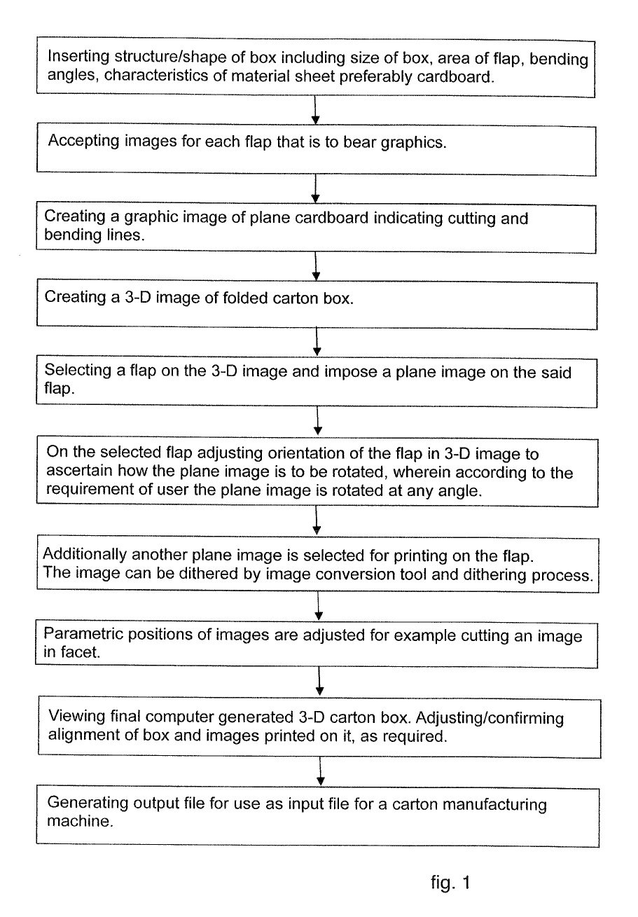

FIG. 1 is used to describe embodiments according to the present disclosure of a flowchart of a possible method embodiment of the invention. Using this method, graphics (images) can be accurately created for printing on a cardboard from which surfaces and flaps can be cut and bended to form a 3-D carton with images printed thereon. The method provides for a user the ability to achieve good alignment, required shape and size of the images on the completed 3-D carton, with less man powder and reduced human error compared to conventional methods.

The method of FIG. 1 is implemented on a processing system, e.g., a computer system. in step 1, carton structural information relating to the physical characteristics of the carton is inserted as input. In one embodiment, this information includes parameters such as the overall length, width, and depth dimensions of the carton, the area and orientation of each surface, and flap, the bending lines and bending angles associated the surface and flaps; and the bend order. Other structural information can include thickness and composition of the cardboard, including case of bending information.

In next step, the method accepts images for each surface or for completed carton. The images may already exist, e.g., in the form of graphic files, or a graphics artist may create the images. Even if the images are from an existing file, the images may still need to be manipulated so as to be suitable for printing on the final carton.

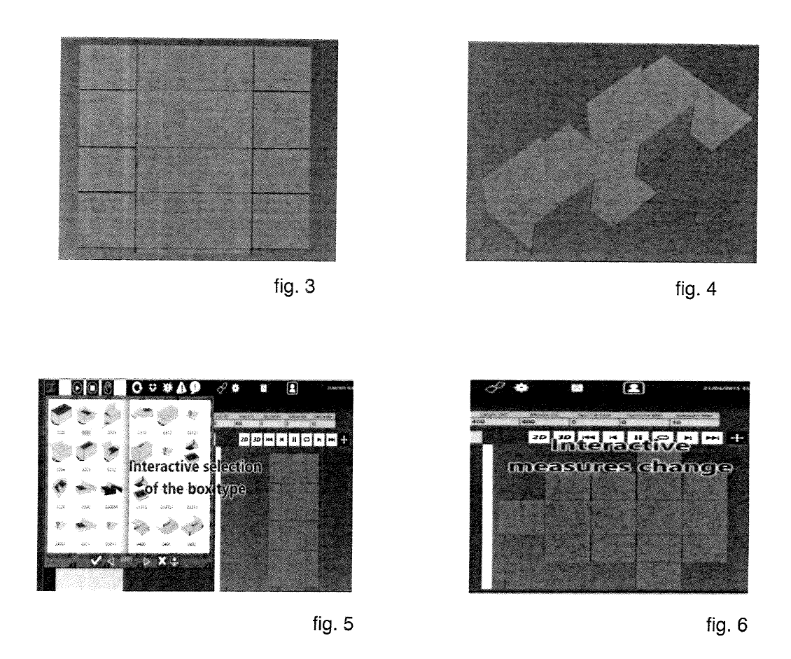

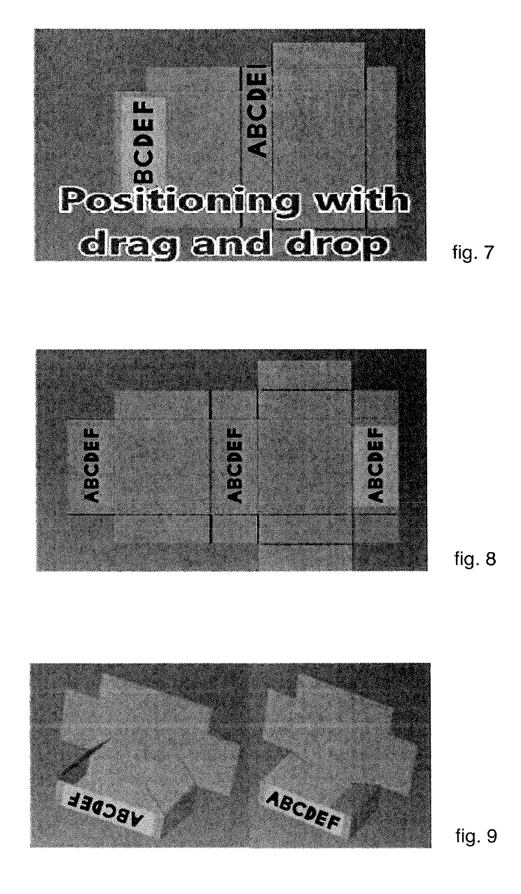

In next step the method uses the carton structural information to create a model of the cardboard, and to display, e.g., in FIG. 3, image of the unfolded cardboard, indicating where the cut lines and bending lines are located. The bends cuts, and dimensions may, for example be displayed in different colors.

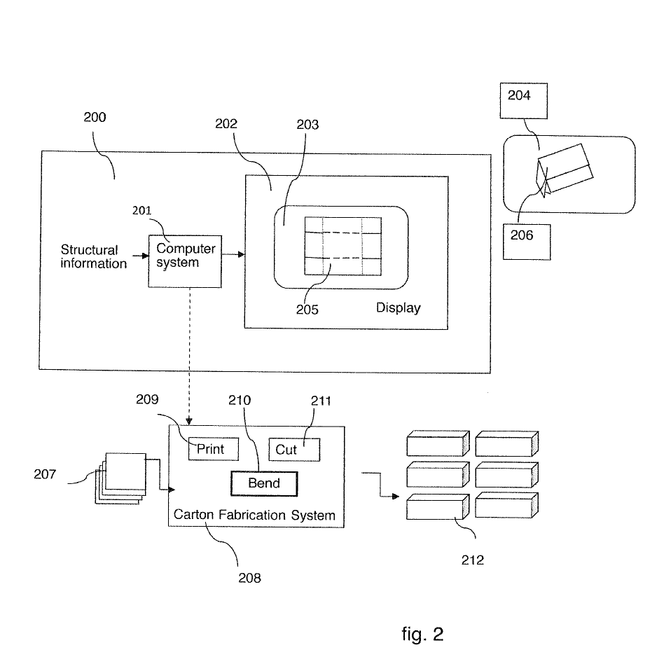

In next step, the method uses the carton structural information to form a 3-D model of the carton, and displays a perspective 3D view, e.g., a shaded surface view of the 3D carton as depicted in FIG. 4. Note that in one embodiment operating on a system that includes a display subsystem in FIG. 2 with at least two screens, e.g., 203 and 204.

From step 5 to 8 the user selects flaps over which images/designs are placed. This is typically carried out flap-by-flap. In step 6 on the selected flap is adjust orientation of the flap in 3-D image to ascertain how the plane image is to be rotated. According to the requirement of user the plane image can be rotated at a desired angle and further it may be flipped or screwed towards its modification.

In further step 7 additionally another plane image is selected for printing on flap. The image can be dithered by image conversion tool and dithering process.

In next step 8, parametric positions of images are adjusted for example cutting an image in facet.

In next step the final computer generated 3-D carton box is viewed. As per requirement user can adjust/confirm the alignment of box and images printed on it.

In the last step an output file is generated, this output file is used as input file for carton manufacturing machine.

According embodiments, a user terminal can be provided including a data storage unit, or data storage means, or data storage device, a computing unit, or computing device, an input/output unit, and an interface, or GUI (Graphical User Interface). The user terminal can be such as but not limited to mobile phone, palmtop computer, PDA (Personal Digital Assistant), laptop, notebook, netbook, ultrabook, PC (Personal Computer), tablet, smartphone, phablet etc. A computer program code operable to perform the functioning of the invention is stored in the data storage and is able to be executed by the computing unit. The computer program code when executed by the computing unit, provides the graphical user interface to a user or operator of the user terminal. The user can provide inputs into the graphical user interface with the help of the input/output unit and input/output means. The input/output means can be such as but not limited to buttons, physical buttons, virtual buttons, keyboard, mouse, electronic pen, touch screen, voice command devices, optoelectronic input devices, gesture or movement recognition devices or other.

The computer program code can be further configured to perform diagnostics of the results of the execution of the method of the invention. The diagnostics may include identifying any errors present any of the steps performed by the method of the invention. The computer program code is also configured to generate at least a warning or an alarm when an error is identified. Also the computer program code is configured to advise the user that the one or more of the steps performed according to the invention have errors. At the same time, the computer program code can provide suggestions to the user by indicating how to correct an error.

FIG. 2 shows a graphics creation system 200 that includes a computer system 201 that has a CPU and a memory that typically includes persistent and non-persistent memory. Stored or loadable into memory are software instructions of a software program that when executed by CPU will cause a method embodiment of the present invention to be carried out. As indicated in FIG. 2, in some systems, the complete set of programming instructions of the program that when executed implements the method may be stored on a storage medium, such as optical or magnetic storage, to be read into computer system 201. Those skilled in the art will recognize the storage media may in fact be part of the computer system, or may be physically remote from computer system 201, and may, if desired, be accessed over a communications link such as the Internet, a network, etc.

Computer system 201 also receives as input carton structural information pertaining to the carton to be generated. This information may be in a file on storage, or may be manually input by the user, or may be provided to the computer system in some other way.

As CPU executes instructions of the program, the user can create and then lay out the various graphic elements, e.g., images and/or text for the surface and flap areas of a carton. Commercially available graphic design software is known in the art, and may be used as part of program at this juncture. Alternatively, dedicated code may be included in software for this task.

The computer system includes a display subsystem 202 that includes one display screen at a time. One such screen is shown in FIG. 2. The user can view on display screens 203 views of the carton being designed. Shown in screen 203 is a unfolded view 205 of the carton showing cuts and bends, while shown in other screen 204 is a 3D shaded view of 206 of the complete carton corresponding to the unfolded view 205. The displayed images may manipulate and new images viewed. For example, as described in more detail below, the user can superimpose on a screen, e.g., display 203, upon a planar outline of the carton 205. Program uses the structural information to copy and position the images on the various flaps that contribute to the surface being worked on.

Since the structural information available to program includes bending details and characteristics of the cardboard, the user can readily determine areas of surfaces and flaps that need not be printed at all because they are covered by portions of other surfaces or flaps. At this juncture, appropriate clipping masks can be generated by program such that covered-over cardboard portions are not needlessly printed with images.

As described in more detail below, the user can also cause program to create a 3-D image of the carton. One such image 206 has been shown as being displayed on screen 204. In FIG. 4, four flaps are bended at 90° angle, and image has been rotated to permit in view 206 an end-on view of the side flap and the composite image printed on the surface.

By obtaining the desired images the system program can generate an output file which work as input for a carton fabrication system 208 is depicted in FIG. 2 as receiving data and information that is input from output file and also receiving as input plane cardboard 207 that is to be printed, according to aspects of the present invention.

The carton fabrication system 208 has been divided mainly into three subsystems; printing subsystem 209, cutting subsystem 211 and bending subsystem 210. System 209 performs the printing operation of images, 211 perform cutting operation of cardboard according to measurements and 210 perform bending operation that will bend already printed and cut cardboard.

The final 3-D virtual carton visible on the computer screen is the input to the carton manufacturing machine.

Drawing such a guide line segment provides two (x, y) coordinates on the unbended sheet. The method uses these two (x, y) coordinates defining a line on the intersection of the desired surface with one of the flaps to determine which flap in the 3D model the guide line segment is on.

An indicative logic and the instructions encoded in the XML format to execute the method of the invention is indicated hereinbelow, wherein said XML encoded logic and the instructions are used for defining and selecting the model of the box. This XML files contains the information for all the workings to be performed with a working machine for cutting/shaping/creasing a carton blank and furthermore the information for creating and visualizing the 3D animation of the same box, which can be used as visualization aid for the operator/user that has to bend flaps and form the final box starting from the worked/cut/creased/shaped carton blank.

<xs: schema xmlns:xs=″http://www.w3.org/2001/XMLSchema″ attributeFormDefault=
″unqualified″ elementFormDefault=″qualified″>
<xs:element name=″t_format_fields_file″>
<xs:complexType>
<xs:sequence>
<xs:element type= “xs:short″ name=”name_box />
Default parameters
<xs:element type=″xs:short″ name=″length”/>
<xs:element type= ″xs:short″ name=″width″/>
<xs:element type=″xs:short″ name=″height″/>
<xs:element type=″xs:byte″ name=″thickness/>
<xs:element type=″xs:byte″ name=″increasing_length”/>
<xs:element type=″xs:byte″ name=″increasing_width”/>
<xs:element type=″xs:byte″ name=″increasing_height”/>
<xs:element type=″xs:byte” name=″selection_packaging_1_2″/>
<xs:element type=″xs:byte″ name=”selection_direction″/>
<xs:element type=″xs:byte″ name=”selection_upturn”/>
<xs:element type=″xs:byte″ name=″creasing_special”/>
<xs:element type= ″xs:byte″ name=″exclude_trimmers”/>
<xs:element type=″xs:byte″ name=″optimize_scraps”/>
<xs:element type=″xs:string″ name=″optimize_dx”/>
<xs:element type=″xs:string″ name= ″optimize_sx”/>
<xs:element name=″parameters_K”>
<xs:complexType>
<xs:sequence>
<xs:element type=″xs:byte″ name=″int″/>
</xs:sequence>
</xs:complexType>
</xs:element>
<xs:element type=”xs:string″ name=″rules″/>
<xs:element type=”xs:string″ name=”file_set″/>
List of workings for making the box
<xs:element name=″workings″>
<xs:complexType>
<xs:sequence>
<xs:element name ″t_working_for_file″ maxOccurs=”unbounded″ minOccurs=”
0″>
<xs:complexType>
<xs:sequence>
Coordinates and types of working
<xs:element type=”xs:string” name=″xO″/>
<xs:element type=″xs:string″ name=″y0”/>
<xs:element type=”xs:string” name=″length_segment″/>
<xs:element type=”xs:string” name=”type_working”/>
<xs:element type=″xs:string″ name=″aux”/>
Rotation angles of the workings for the 3D animation of the box closing
operations
<xs:element type″xs:string″ name=″sideRoot″ minOccurs=″0″/>
<xs:element type=″xs:byte″ name=″angle″ minOccurs”0”/>
<xs:element type=″xs:byte″ name=″arrangement″ minOccurs=″0”/>

| | |
|---|---|
| </xs:sequence> | < |

</xs:complexType>
</xs:element>
</xs:sequence>
</xs:complexType>
</xs:element>
</xs:sequence>
</xs:complexType>
</xs:element>
</xs:schema>

However, it comes within the spirit of the present disclosure to provide logic and the instructions to execute the method of the invention encoded in a text string, in particular containing alphanumeric characters, such as based on an ASCII table, or an electronic database, using a database query, for instance using standard SQL, or an electronic spreadsheet, or combination thereof.

Some embodiments of the method according to the present disclosure can be included in a computer program storable in a mean readable by a computer that contains the instructions which, once executed by a system according to the present disclosure, determine the execution of the method according to the present disclosure. In particular, elements according to the present disclosure can be supplied as means readable by a machine to store the instructions that can be executed by the machine. The machine-readable means can include, without being limited to, floppy disks, optical discs, CD-ROM, and magneto-optical discs, ROM, RAM, EPROM, EEPROM, optical or magnetic boards, propagation means or other types of machine-readable means suitable to store electronic information. For example, the present invention can be downloaded as a computer program which can be transferred from a remote computer (for example a server) to a computer making a request (for example client), by data signals achieved with carrier waves or other propagation means, via a communication connection (for example a modem or a network connection).

While the foregoing is directed to embodiments of the invention, other and further embodiments of the invention may be devised without departing from the basic scope thereof, and the scope thereof is determined by the claims that follow.

1. A method of operating a processing system that includes at least one processor and a storage system, wherein said method comprises:
selecting one desired type of carton box from a group or list of available different types of carton boxes displayed on computer screen according to a computer program code;
generating, by said computer program code, virtually displaying three dimensional images of carton boxes on the computer screen, said virtually displaying comprising three-dimensionally displaying a progressive formation of a selected final closed carton box by bending and/or rotating flaps, walls or surfaces of a starting canon blank sheet made of corrugated paperboard having a mating, or conjugated, shape and intended for the formation of said selected final closed carton box;
wherein at least said virtually displaying is provided according to interactive instructions and tools configured towards controlling and guiding the generation and modification of virtual three dimensional images, selecting one or more optional parametric values.

2. A method as claimed in claim 1, wherein the logic and instructions encoded for one or more computer readable medium to execute said method are encoded in XML format.

3. A method as claimed in claim 1, wherein said method provides a computer readable medium with coded instructions to execute the method towards virtually displaying three dimensional images of carton boxes on computer screen and optionally optimizing parameters for image printing thereof.

4. A method as claimed in claim 1, wherein said method comprises optimizing parameters for image printing on at least one surface or flap of said three dimensional image of carton box.

5. A method as claimed in claim 4, wherein said method comprises executing operations towards virtually displaying three dimensional images of carton boxes on computer screen according to the following steps:
inserting structure/shape of box including size of box, area of flap, bending angles, characteristics of material sheet preferably cardboard;
accepting images for each flap that is to bear graphics;
creating a graphic image of plane cardboard indicating cutting and bending lines;
creating a 3-D image of folded carton box;
selecting a flap on the 3-D image and impose a plane image on the said flap;
on the selected flap adjusting orientation of the flap in 3-D image to ascertain how the plane image is to be rotated, wherein according to the requirement of user the plane image is rotated at any angle.

6. A method as claimed in claim 1, wherein said method comprises a computer program code providing operations towards optimising the parameters for image printing on at least one surface or flap of the carton box according to the following steps:
plane image is selected for printing over the surface or the flap wherein the image is optionally dithered by image conversion tool and dithering process provisioned therein;
setting parametric position of images;
viewing computer generated 3-D carton box.
visually adjusting/confirming alignment of box and images as required;
generating output file for use as input file for a carton manufacturing machine.

7. A method as claimed in claim 1, wherein the logic and instructions encoded for one or more computer readable medium to execute the said method and to control whole process of virtual creation of diagrams, modulation of their shape, size and dimension and managing the printing on at least one surface or flap are encoded in XML format.

8. A method as claimed in claim 5, wherein for virtually displaying images on carton boxes, one or other virtual cartons/boxes can optionally be selected by the user wherein said optional virtual cartons are made available by the logic and encoded instructions while executing the said method.

9. A method as claimed in claim 6, wherein an image is imposed over the different surface/flaps of the carton, and wherein these images are preferably positioned by drag and drop method.

10. A method, as claimed in claim 6, wherein the printing patterns can be selected on perfect parametric positions on chosen surface/flap; and wherein the image is optionally dithered by image conversion tool and dithering process provisioned therein, and wherein further optionally printing approximates a color from a mixture of other colors, when the required color is not available.

11. A method, as claimed in claim 1, wherein the logic and instructions encoded for one or more computer readable medium to execute said method are encoded in a text string, in particular containing alphanumeric characters, such as based on an ASCII table.

12. A method, as claimed in claim 1, wherein the logic and instructions encoded for one or more computer readable medium to execute said method are encoded in an electronic database, in particular are based on a database query.

13. A method, as claimed in claim 1, wherein the logic and instructions encoded for one or more computer readable medium to execute said method are encoded in an electronic spreadsheet.

14. A non-transitory computer readable medium including at least computer program code for executing a method according to claim 1.

15. A user terminal, wherein said user terminal comprises:
a computing device configured to execute computer program code for executing a method according to claim 1;
a data storage device configured to store computer program code that is able to be executed by the computing device, the computer program code stored in the data storage device including at least:
computer program code for providing an interface to receive a plurality of inputs from a user of the user terminal, wherein said plurality of inputs is intended to select at least one desired type of carton box from a group or list of available different types of carton boxes displayed on computer screen.

16. A user terminal according to claim 15, wherein the computer program code stored in the data storage device further includes computer program code for providing an interface to receive a plurality of inputs from a user of the user terminal, wherein said plurality of inputs is intended to select, control, position at least one image printing on at least one surface or flap of the three dimensional image of carton box.

17. A server, comprising:
a database to store at least a plurality of personalized preferences, wherein the preferences are collected from a plurality of users;
a processing device configured to create clusters of the personalized preferences according to a plurality of parameters;
wherein the personalized preferences are personalized preferences regarding at least specific and/or most recurrent desired types of carton boxes selected by a user from a group or list of available different types of carton boxes and optionally regarding specific most recurrent desired image printings on at least one surface or flap of the three dimensional image of carton box.

18. A computer system for visually and virtually aiding and/or guiding a user and/or operator at least in the formation of carton boxes, wherein said system comprises:
a data storage means storing computer program code that is able to be executed by a computing device, the computer program code being configured to provide an interface to a user to provide a plurality of inputs, wherein the provided inputs are used by the computer code at least to generate execute a method according to claim 1.

19. A computer readable storage medium having the logics and instructions encoded thereon that when executed by one or more processors of a processing system that includes at least one processor and storage subsystem, cause execution of the method comprising creation of virtual diagrams, modulation of their shape, size and dimension and optionally managing the printing on at least one surface or flap.
